(19) United States
(12) Patent Application Publication
(10) Pub. No.: US 2022/0138537 A1
(43) Pub. Date: May 5, 2022

(54) PROBABILISTIC NONLINEAR RELATIONSHIPS CROSS-MULTI TIME SERIES AND EXTERNAL FACTORS FOR IMPROVED MULTIVARIATE TIME SERIES MODELING AND FORECASTING

(71) Applicant: INTERNATIONAL BUSINESS MACHINES CORPORATION, ARMONK, NY (US)

(72) Inventors: Brian Leo Quanz, Yorktown Heights, NY (US); Nam H. Nguyen, Pleasantville, NY (US)

(21) Appl. No.: 17/087,568

(22) Filed: Nov. 2, 2020

(51) Int. Cl. G06N 3/04; G06N 3/08; G06K 9/62

(52) U.S. Cl. CPC G06N 3/0472; G06N 3/049; G06K 9/6256; G06N 3/08; G06N 3/0481

(57) ABSTRACT

A computing device for time series modeling and forecasting includes a processor, and a memory coupled to the processor. The memory stores instructions to cause the processor to perform acts including encoding an input of a multivariate time series data, and performing a non-linear mapping of the encoded multivariate time series data to a lower-dimensional latent space. The next values in time of the encoded multivariate time series data in the lower dimensional latent space are predicted. The predicted next values and a random noise are mapped back to an input space to provide a predictive distribution sample for a next time points of the multivariate time series data. One or more time series forecasts based on the predictive distribution sample are output.

### BACKGROUND

### Technical Field

The present disclosure generally relates to computer-implemented methods and systems for time series modeling, and more particularly, to multivariate time series modeling and forecasting.

### Description of the Related Art

Modeling and forecasting across large numbers of time series data to capture cross-series effects continues to be a struggle.

For example, manual heuristic approaches lack the flexibility to capture the cross-series effects, and such approaches are not scalable. There are cross-product effects that can occur in demand forecasting with thousands to even billions of product-location combinations.

There is also a lack of ability to capture underlying non-linear relationships and effects across time series. Further, there are problems attempting to factor in cross-relationships with exogenous information and other factors.

The result is that poor, incorrect decisions are made based on flawed models, leading to increased inefficiencies, increased costs, wasted resources, missed opportunities, and the production of inferior products.

Accordingly, there is a need for a scalable automated way to model nonlinear, probabilistic relationships between series and incorporate this into improving forecasting.

### SUMMARY

According to one embodiment, a computing device for time series modeling and forecasting includes a processor, and a memory coupled to the processor. The memory stores instructions to cause the processor to perform acts including encoding an input of a multivariate time series data, and performing a non-linear mapping of the encoded multivariate time series data to a lower-dimensional latent space. The next values in time of the encoded multivariate time series data in the lower dimensional latent space are predicted. The predicted next values and a random noise are mapped back to an input space to provide a predictive distribution sample for a next time points of the multivariate time series data. One or more time series forecasts based on the predictive distribution sample are output. There is an improvement in accuracy and in the time to process the time series modeling and forecasting.

In one embodiment, the computing device is configured to train a neural network deep learning model to compute a time series modeling and the one or more time series forecasts. The use of a neural network increases the efficiency of the time series modeling and forecasting.

In one embodiment, the training of the deep learning model is unsupervised. The use of unsupervised training permits a broader recognition of patterns and aids in discovering hidden patterns.

In one embodiment, the deep learning model is an end-to-end deep learning model trained using a stochastic gradient descent. The end-to-end learning model makes the entire operation more efficient, and the use of the stochastic gradient descent can minimize input space prediction errors.

In one embodiment, the end-to-end deep learning model includes an encoder neural network configured to encode an input of a multivariate time series data, a temporal predictor network is configured to predict the next values in time from the encoded multivariate time series data received from the encoder neural network, and a decoder neural network is configured to map the predicted next values from the temporal predictor network to an input space. The use of neural networks increases the efficiency of operations and facilitates training.

In one embodiment, the decoder neural network is additionally configured to map a combination of the random noise and latent space values back to the input space. The random noise is used to increase the pattern detection.

In one embodiment, the encoder neural network is additionally configured to encode an exogenous factor data per series and a time point of the input multivariate time series data prior to performing the non-linear mapping of the encoded multivariate time series data to a lower-dimensional latent space. The use of exogenous data improves the accuracy of the prediction by taking into account factors not found in the time series data.

In one embodiment, the input multivariate time series data and the exogenous factor data is arranged as a 3D array, with a third dimension corresponding to features of the exogenous factor data.

In one embodiment, the encoder neural network is a temporal auto-encoder. The temporal auto-encoder improves the temporal matrix factorization.

In one embodiment, the encoder neural network is a probabilistic temporal auto-encoder. The probabilistic temporal auto-encoder a relatively simple structure that can be introduced on latent variables, with a continued ability to model complex distributions of the multivariate data via decoder mapping.

In one embodiment, a number of auto-encoded temporal patterns output by the temporal auto-encoder is less than a number of the input multivariate time series data. The reduced number speeds up the time to output the forecasts.

According to one embodiment, a computer-implemented method of multivariate time series modeling and forecasting, the computer-implemented method includes encoding a plurality of inputs of multivariate time series data, mapping the encoded multivariate time series data to a lower-dimensional latent space, predicting the next values in time of the encoded multivariate time series data in the lower dimensional latent space, and mapping the predicted next values and a random noise back to an input space to provide a predictive distribution sample for a next time points of the multivariate time series data. There is an output of one or more time series forecasts based on the predictive distribution sample. There is an improvement in accuracy and in the time to process the time series modeling and forecasting.

In one embodiment, the encoding of the plurality of multivariate time series data is performed by temporal auto-encoding. The temporal auto-encoder improves the temporal matrix factorization.

In one embodiment, the encoding of the plurality of multivariate time series data is performed by probabilistic temporal auto-encoding.

In one embodiment, a number of auto-encoded input multivariate time series data is greater than a number of auto-encoded temporal patterns output by the temporal auto-encoder. There is an increased speed in processing.

In one embodiment, the mapping of the encoded multivariate time series data to a lower-dimensional latent space is performed non-linearly. The non-linear mapping can increase the finding of hidden patterns.

In one embodiment, a deep learning model of a neural network is trained to compute a time series modeling and the one or more time series forecasts.

In one embodiment, an end-to-end deep learning model is provided and the end-to-end deep learning model is trained using a stochastic gradient descent. A reconstruction error, a latent space prediction error, and an input space prediction error can be minimized via the use of a stochastic gradient descent.

In an embodiment, the input multivariate time series data and the exogenous factor data are formed as a 3D array, with a third dimension corresponding to features of the exogenous factor data. The use of exogenous data improves the accuracy of the prediction by taking into account factors not found in the time series data.

According to an embodiment, a non-transitory computer-readable storage medium tangibly embodying a computer-readable program code having computer-readable instructions that, when executed, causes a computer device to perform a method of multivariate time series modeling and forecasting, the method including encoding a plurality of inputs of multivariate time series data. The encoded multivariate time series data is mapped to a lower-dimensional latent space. The next values in time of the encoded multivariate time series data in the lower dimensional latent space are predicted. The predicted next values and a random noise are mapped back to an input space to provide a predictive distribution sample for the next time points of the multivariate time series data. One or more time series forecasts based on the predictive distribution sample are output. There is an improvement in accuracy and in the time to process the time series modeling and forecasting.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 provides an architectural overview of a system for multivariate time series modeling and forecasting, consistent with an illustrative embodiment.

FIG. 2 illustrates an encoder neural network incorporating exogenous factors per time series, consistent with an illustrative embodiment.

FIG. 3 illustrates a temporal auto-encoder, consistent with an illustrative embodiment.

FIG. 4 illustrates a probabilistic temporal auto-encoder, consistent with an illustrative embodiment.

FIGS. 5A and 5B illustrate dataset statistics and running time per epoch to show the improved functionality of the computer-implemented method of the present disclosure.

FIG. 6 is a flowchart illustrating a computer-implemented method of time series modeling and forecasting, consistent with an illustrated embodiment.

FIG. 7 is a functional block diagram illustration of a computer hardware platform that can communicate with, consistent with an illustrative embodiment.

FIG. 8 depicts an illustrative cloud computing environment, consistent with an illustrative embodiment.

FIG. 9 depicts a set of functional abstraction layers provided by a cloud computing environment, consistent with an illustrative embodiment.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high-level, without detail, to avoid unnecessarily obscuring aspects of the present teachings.

As used in some illustrative embodiments herein, the term “latent space” refers to an abstract multi-dimensional space including feature values that are not directly interpreted, but such feature values are used to encode a meaningful internal representation of externally observed events. In addition, the term “a lower-dimensional latent space” refers to a reduction of an original spectral dimension to increase the efficiency of a search.

The term “input space” is understood in machine learning as all the possible inputs. For example, in illustrative embodiments, the random noise samples are decoded to provide predictive distributions. A decoder may be configured for mapping the random noise back to the input space.

In addition, the term “stochastic gradient descent” generally refers to a method of decreasing the error by approximating the gradient for a training sample. In some illustrative embodiments, a reconstruction error, a latent space prediction error, and an input space prediction error can be minimized via the use of a stochastic gradient descent.

The computer-implemented method and device of the present disclosure provide for an improvement in the fields of time series modeling and forecasting. Increased accuracy in time series modeling and forecasting provides for improved efficiency in fields as varied as health (e.g. the production and distribution of medicines, vaccines, etc.), food, waste management, communications (e.g. network operations, Internet traffic, data streaming) just to name a few non-limiting examples.

In addition, the computer-implemented method and device of the present disclosure provide an improvement in the efficiency of computer operations. By virtue of the teachings herein, the technical improvement results in a reduction in the amount of processing requirements and power. For example, improved forecasting accuracy results in fewer iterations, thus freeing computer resources. There is also realized a time savings using the teachings of the present disclosure.

### Example Architecture

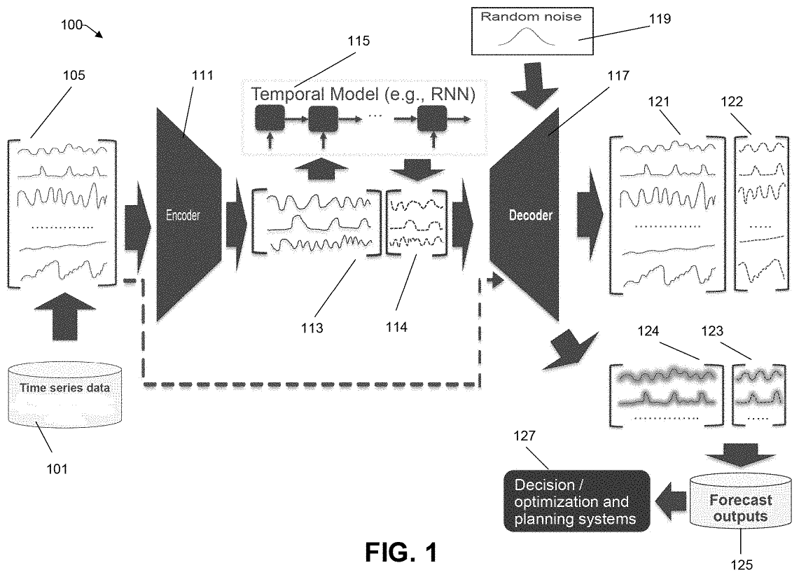

FIG. 1 provides an overview of an architecture 100 for multivariate time series modeling and forecasting consistent with an illustrative embodiment. A time series data 101 is, in this illustrative embodiment, multivariate time series data. Multivariate data is data in which an analysis is based on more than two variables per observation. Multivariate time series data 105 is a collection of multiple variables at subsequent time points. A plurality of multivariate time series data 105 is shown to depict some of the various data patterns. The multivariate data is input to the encoder 111. The encoder 111 is configured to encode the multivariate time series data into a smaller number of shared/global underlying temporal patterns 113 and non-linear combinations of the input time series data that are cleaned and de-noised. The encoder also performs a non-linear mapping of the encoded multivariate time series data to a lower-dimensional latent space. As discussed herein above, the term “a lower-dimensional latent space” refers to a reduction of an original spectral dimension to increase the efficiency of a search.

A temporal model 115 receives the encoded multivariate time series data and predicts the next values of the encoded multivariate time series data in the lower dimensional space. Predicted next values are provided as forecasts 114 in latent space by the temporal model 115. In this illustrated embodiment, the temporal model 115 is a Recurrent Neural Network (RNN), and may be referred to as a temporal predictor network. However, the temporal model 115 of the present disclosure is not limited to being an RNN.

A decoder 117 receives the forecast 114 of the predicted next values and is configured for mapping the predicted next values from the temporal model to an input space. The decoder 117 receives noise from a random noise generator 119 which is combined with the latent series values and forecast 114 to create random noise samples in the latent space, for example, by directly adding the random noise to the values and forecast. The forecast(s) can include any properties of the joint distribution—including the mean or median, variance, different quantiles, etc. The decoder 117 decodes the random noise samples to provide sampled predictive distributions 123, 124 over a time series. Also shown are reconstructed series mean input series 121 (0 noise input) and reconstructed mean forecasts 122 (0 noise input). The forecasts may be output to storage 125 and then output to decision/optimization and planning systems 127. The output of the forecasts may be used according to user desire. Thus it can be seen from the architecture shown in FIG. 1 that the time series modeling and forecasting provide an output that can be used by the algorithms of other systems.

With regard to the illustrative embodiment, the latent space includes the latent/global series and the forecast. As described herein above, the random noise is directly added to the latent space values/forecasts. However, there are additional ways of combining random noise with the latent space values/forecasts. For example, if the forecast involved both a mean and standard deviation prediction, the random noise can be transformed to have the output standard deviation in the latent space—e.g., scale the forecast by the standard deviation output before adding it to the mean outputs.

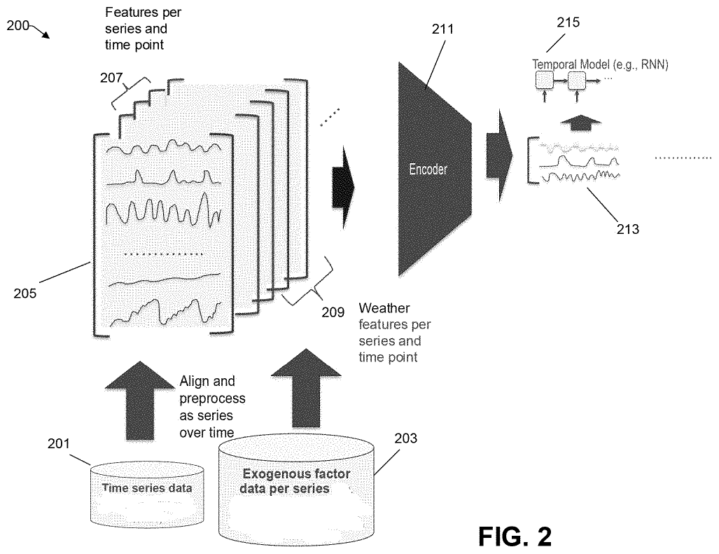

FIG. 2 illustrates an encoder neural network 200 incorporating exogenous factors per time series, consistent with an illustrative embodiment. The encoder 211 in this illustrative embodiment is configured to receive exogenous factor data per series 203 along with time series data 201 (e.g., certain features per series and time point) in a case where the inputs are arranged as a tensor, and wherein the exogenous factor data is added alongside the time series data as another dimension, such as to form a 3D array or tensor) in which the additional dimension corresponds to external features from the external data for each individual time series. A temporal model 215 may operate as described with regard to FIG. 1.

The time series data 205 is shown as being supplemented with weather features per series and time point 209. Feature series and time point can be any feature that is desired to be forecast or that may influence forecasts for the target series. For example, if the time series data 205 is Internet traffic, and a major sporting event is going to take place, the sporting event 207 can be the features and time of the game. The weather features 209 can affect the sporting event, cause a delay of game, etc., and the Internet traffic of viewers streaming the event can permit Internet traffic to be forecast. For example, a communications company may increase network capacity, if possible, making as many network server operable as may be appropriate to handle the traffic.

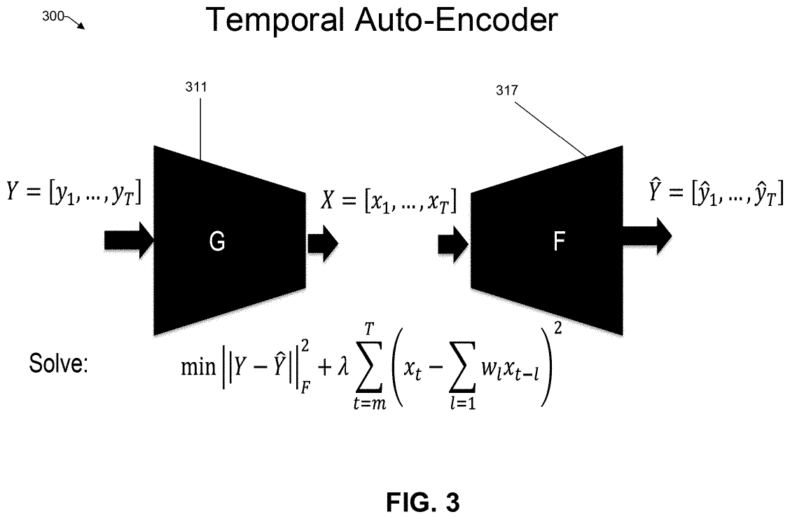

FIG. 3 illustrates a temporal auto-encoder 300, consistent with an illustrative embodiment. An encoder 311 and decoder 317 are shown. The temporal auto-encoder 300 may be embodied as a multivariate temporal auto-encoder, may be configured to find latent features corresponding to latent time series, and represent them in a hidden state vector per time point. The latent time series are modeled as having an explicit temporal pattern that is described by some latent temporal model, that models how the time series progress over time and interact in the latent space, in a possibly nonlinear way. One such temporal model is illustrated in the equation in the Figure, in which future time series values of the latent time series (x for a particular t) are a linear function—a weighted sum—of prior latent time series values. More complex non-linear temporal models are also proposed such as recurrent neural networks (RNNs) or temporal convolutional neural networks (TCNs)—in general future latent values are functions of prior latent values. The entire process of the temporal auto-encoder can therefore be modeled as one end-to-end sequence of operations or functions—that is, mapping the input space time series to the latent space and back again to the input space, after transformations in the latent space. Each step can be modeled with an arbitrary function such as a neural network of various different architecture types. As such, as in the same way temporal models including neural nets like RNNs and TCNs can be trained with time series and sequence data, this whole end-to-end model that includes the entire flow can be trained in the same way using sub-sequences, or batches, of the time series—and where all components, i.e., encoder, decoder, and latent temporal model are optimized jointly at the same time through the use of stochastic gradient descent and back-propagation to compute the gradient at each update step.

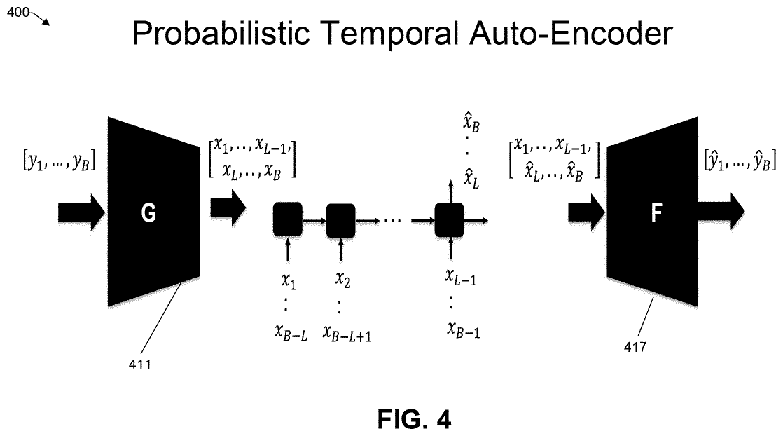

FIG. 4 illustrates a probabilistic temporal auto-encoder 400, consistent with an illustrative embodiment. Encoder 411 and decoder 417 are shown. One of the problems with time series forecasting is how future values can be probabilistically modeled. According to this illustrative embodiment, the high dimensional data is encoded to lower-dimensional embedding, and a latent-space probabilistic model is based on the lower-dimensional embedding. Prediction samples can be obtained by sampling from the latent distribution and translating the prediction samples through a decoder to obtain probabilistic samples in the (more complex) input space. If the encoder is sufficiently complex to capture a non-linear correlation among a series, and the decoder sufficiently complex to map a simple distribution to a more complex one (similar to the idea of inverse transform sampling commonly used in statistics), then a relatively simple probabilistic structure can be introduced on latent variables, with a continued ability to model complex distributions of the multivariate data via decoder mapping.

With continued reference to FIG. 4, a variational operation similar to the idea of variational auto-encoders (VAE) can be used to draw samples in the latent space. More particularly, the latent space variance σ² is fixed to “1” to simplify the modeling and avoid overfitting in equation 1 below:

P(xₗ₊₁|x₁, . . . ,x₁)=N(xₗ₊₁|μ,σ²), (Eqn. 1)

wherein “P” is a probability, xₗ₊₁ is the next value of the multivariate latent-space series and “N” is the probability of the next value given the prior observed values in the latent space.

This probability P is assumed here without loss of generality to follow a Normal distribution, with mean given by the forecast mean for the next value xₗ₊₁ which is the output of the latent temporal model, and standard deviation either given by another output of the latent temporal model, for example, or fixed to a constant value (e.g., “1”) as explained above. In this way samples can be done by drawing random samples from the given probability distribution in the latent space, given latent temporal model outputs. These translated samples in the input space then correspond to samples from the joint distribution of future values across the time series, as the decoder and latent space models are fit to the observed data. From these joint distribution samples, any properties of the distribution can be provided as different types of forecasts. For example, these properties can include the mean or median, variance, different quantiles, etc. These properties can be used to provide different types of key forecasts for different uses, such as a median and forecast of the 5^{th} and 95^{th} percentiles to provide a standard prediction interval.

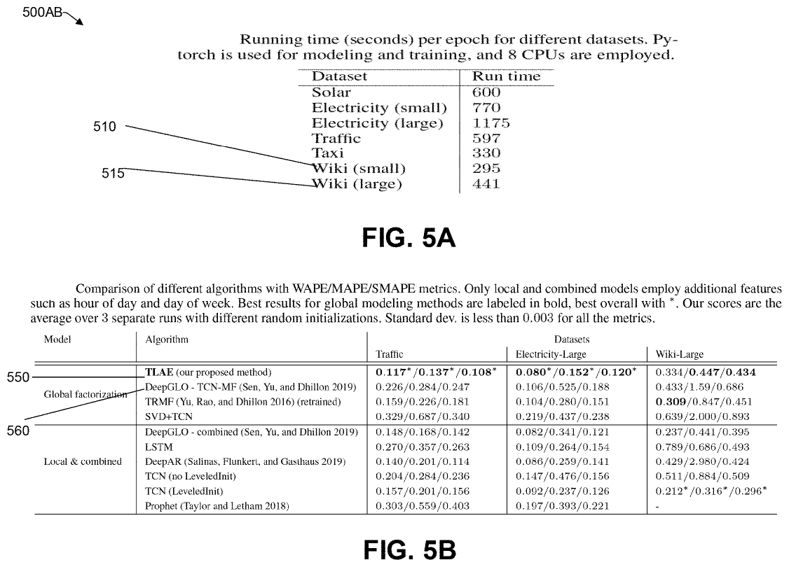

FIGS. 5A and 5B illustrate running time per epoch and a comparison with other algorithms to show the improved functionality of the computer-implemented method of the present disclosure. FIG. 5A shows that the large version 515 of Wiki took only 1.5 times more per epoch than the small version 510 of Wiki. However, the large Wiki had 57 times more series than the small, so the computer-implemented method is particularly improved with large data and offers significant savings in time and resources.

FIG. 5B provides comparisons of different algorithms with the computer-implemented method of the present disclosure (identified as “TLAE”). TLAE 550 used a smaller latent space size than DeepGLO 560 and still out-performed all global factorization models compared with. TLAE did not use exogenous predictors like the day of week and hour of the day or local modeling, yet still out-performed all other methods on a majority of datasets.

### Example Process

With the foregoing overview of the example architecture, it may be helpful now to consider a high-level discussion of an example process. To that end, in conjunction with FIGS. 1-5, FIG. 6 depicts a flowchart 600 illustrating a computer-implemented method of time series modeling and forecasting, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

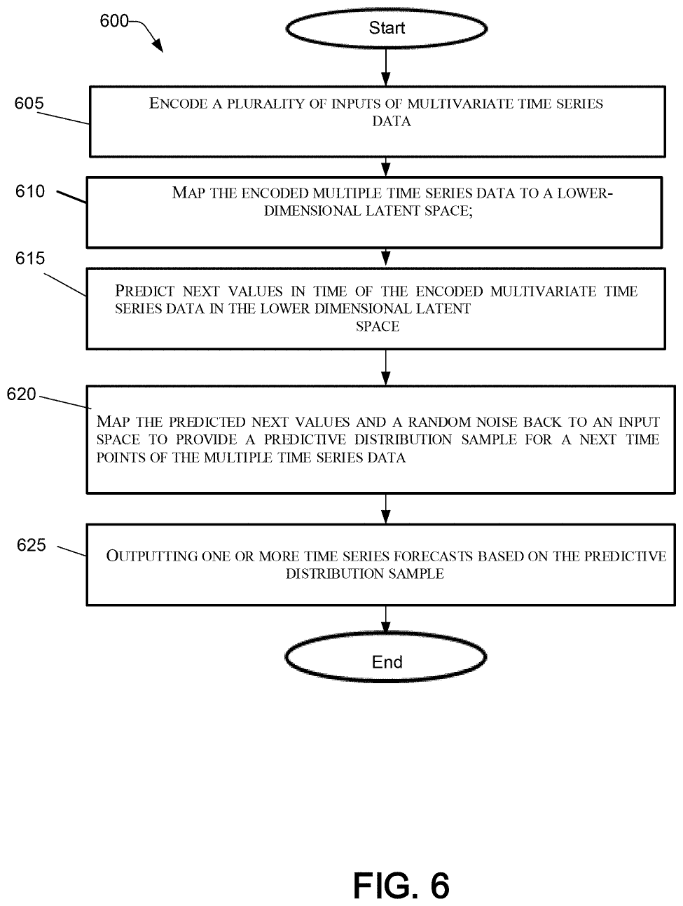

Referring now to FIG. 6, at operation 605, a plurality of inputs of time series data are encoded. The time series data can be virtually any type of data being tracked over time, including but in no way limited to sensor data from electronic devices (both stationary and mobile), electronic vehicles and vehicle traffic flow, production information, product sales, network bottlenecks, etc.

At operation 610, the encoded multivariate time series data is mapped to a lower-dimensional latent space. The lower-dimensional latent space refers to a space from which the low-dimensional representation is drawn. Machine Learning makes use of a lower-dimensional latent space for a number of reasons, including but not limited to, predict missing variables.

At operation 615, there is a prediction of the next values in time of the encoded multivariate time series data in the lower-dimensional latent space. Through successive iterations, a global time series pattern can be accurately captured, and a latent variable in the lower-dimensional latent space can possess its own local properties, and output prediction samples can be calculated from the predicted latent samples.

At operation 620, the predicted next values and a random noise are mapped back to an input space to provide a predictive distribution sample for the next time points of the multivariate time series data. Noise increases the difficulty of identifying patterns, and random noise can be used to assist in decoding and obtain distributions over a series and predictions.

At operation 625, one or more of the time series forecasts based on the predicted distribution sample is output. The output may be stored and/or provided to decision optimization and planning systems. Such systems will operate their own algorithms based in part on the predictive sampling provided.

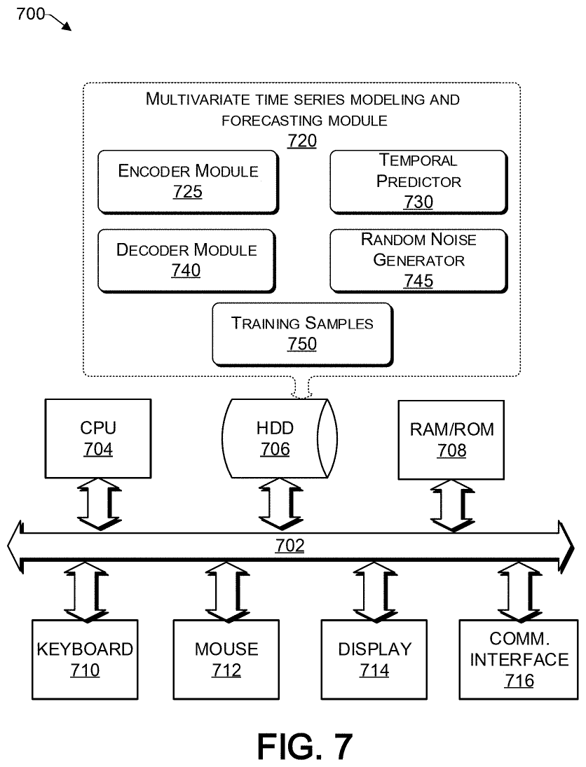

FIG. 7 provides a functional block diagram illustration 700 of a computer hardware platform. In particular, FIG. 7 illustrates a particularly configured network or host computer platform 700, as may be used to implement the method shown in FIG. 6.

The computer platform 700 may include a central processing unit (CPU) 704, a hard disk drive (HDD) 706, random access memory (RAM) and/or read-only memory (ROM) 708, a keyboard 710, a mouse 712, a display 714, and a communication interface 716, which are connected to a system bus 702. The HDD 706 can include data stores.

In one embodiment, the HDD 706, has capabilities that include storing a program that can execute various processes, such as the multivariate time series modeling and forecasting module 720, in a manner described herein. Multivariate time series modeling and forecasting module is an end-to-end deep learning model, according to certain illustrative embodiments described herein. The end-to-end deep learning model can be trained using a stochastic gradient descent that can be based on training samples 750.

The encoder module 725 is configured to encode an input of a multivariate time series. The encoder module may 725 be embodied as a neural network. The encoder module 725 may also be configured to receive exogenous factor data per series 203 (see FIG. 2) along with time series data 201 (e.g., certain features per series and time point). In a case where the inputs are arranged as a tensor, the exogenous factor data is added alongside the time series data as another dimension, such as to form a 3D array) in which the additional dimension corresponds to external features from the external data for each individual time series. The encoder module 725 can be configured to increase efficiency, or to enforce sparsity across exogenous factors using attention models. The attention models take all or some inputs/time series and determine which exogenous factors to include how to weight them, potentially multiplying by 0 or excluding certain factor inputs on a case by case basis.

Non-linear combinations of input times series data are cleaned and de-noised by the encoder module 725. The encoder module 725 outputs a smaller number of shared/global patterns as compared with the time series data that was input. The smaller number of shared/global patterns increases the efficiency of operations because the decoder module 740 has fewer patterns to decode. The speed of the time series modeling and forecasting is also increased by the encoder outputting a smaller number of shared/global patterns for the decoder to process.

The temporal predictor 730 is configured to predict the next values from the encoded multivariate time series data received from the encoder module 725. As discussed above, in the case where exogenous factor data per series is included with the time series data (e.g., such as in a 3D array), the temporal predictor 730 is configured to predict the next values based on the encoded time series data and the exogenous factor data. The temporal predictor 730 is configured to provide forecasts in the latent space of a temporal model. The decoder module 740 is configured to map the predicted next values from the temporal predictor 730 back to an input space. A random noise generator 745 adds random noise to the decoder module 740. The random noise samples are decoded to provide distributions over a time series and predictions.

### Example Cloud Platform

As discussed above, functions relating to environmental and ecological optimization methods may include a cloud. It is to be understood that although this disclosure includes a detailed description of cloud computing as discussed herein below, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

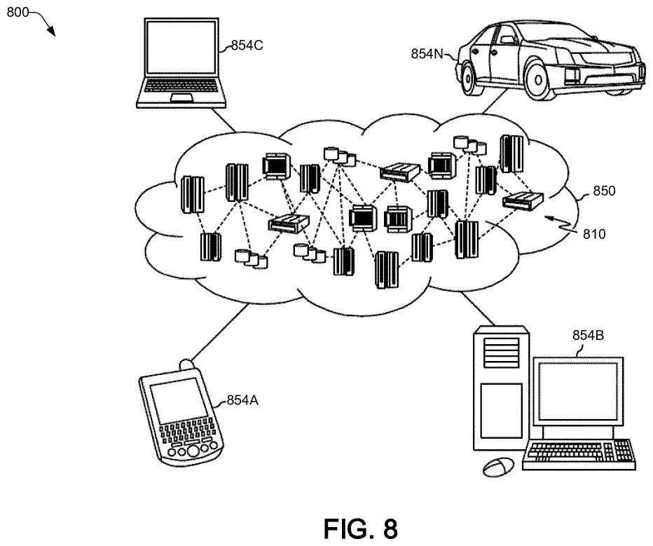

Referring now to FIG. 8, an illustrative cloud computing environment 800 utilizing cloud computing is depicted. As shown, cloud computing environment 800 includes cloud 850 having one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 800 to offer infrastructure, platforms, and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

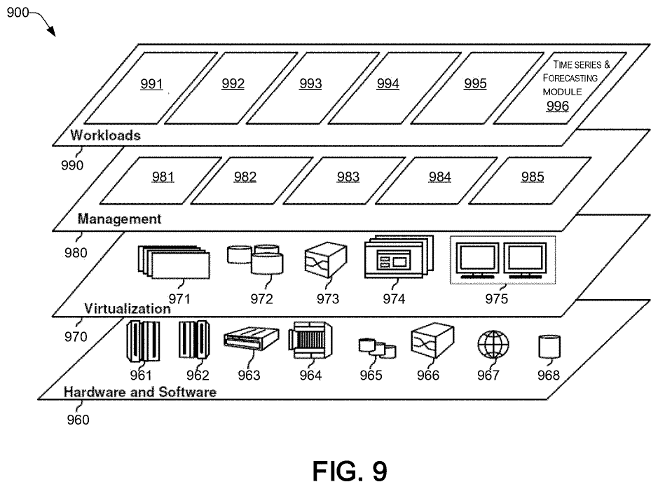

Referring now to FIG. 9, a set of functional abstraction layers 900 provided by cloud computing environment 800 (FIG. 8) is shown. It should be understood in advance that the components, layers, and functions shown in FIG. 9 are intended to be illustrative only and embodiments of the disclosure are not limited thereto. As depicted, the following layers and corresponding functions are provided:

Hardware and software layer 960 include hardware and software components. Examples of hardware components include: mainframes 961; RISC (Reduced Instruction Set Computer) architecture based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and a time series and forecasting module 996 to perform multivariate time series modeling and forecasting, as discussed herein.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

The flowchart, and diagrams in the figures herein illustrate the architecture, functionality, and operation of possible implementations according to various embodiments of the present disclosure.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computing device for time series modeling and forecasting, comprising:
a processor;
a memory coupled to the processor, the memory storing instructions to cause the processor to perform acts comprising:
encoding an input of a multivariate time series data and performing a non-linear mapping of the encoded multivariate time series data to a lower-dimensional latent space;
predicting next values in time of the encoded multivariate time series data in the lower dimensional latent space;
mapping the predicted next values and a random noise back to an input space to provide a predictive distribution sample for a next time points of the multivariate time series data; and
outputting one or more time series forecasts based on the predictive distribution sample.

2. The computing device according to claim 1, wherein the instructions cause the processor to perform an additional act comprising:
training a neural network deep learning model to compute time series modeling and the one or more time series forecasts.

3. The computing device according to claim 2, wherein the training of the deep learning model is unsupervised.

4. The computing device according to claim 2, wherein the deep learning model comprises an end-to-end deep learning model trained using a stochastic gradient descent.

5. The computing device according to claim 4, wherein the end-to-end deep learning model further comprises:
an encoder neural network configured to encode an input of a multivariate time series data;
a temporal predictor network configured to predict next values in time from the encoded multivariate time series data received from the encoder network; and
a decoder neural network configured to map the predicted next values from the temporal predictor network to an input space.

6. The computing device according to claim 5, further comprising a noise generator configured to generate random noise that is input to the decoder neural network,
wherein the decoder neural network is additionally configured to map a combination of the random noise and latent space values back to the input space.

7. The computing device according to claim 5, wherein the encoder neural network is additionally configured to encode an exogenous factor data per series and time point of the input multivariate time series data prior to performing the non-linear mapping of the encoded multivariate time series data to a lower-dimensional latent space.

8. The computing device according to claim 7, wherein the input multivariate time series data and the exogenous factor data is arranged as a 3D array, with a third dimension corresponding to features of the exogenous factor data.

9. The computing device according to claim 5, wherein the encoder neural network comprises a temporal auto-encoder.

10. The computing device according to claim 9, wherein the encoder neural network comprises a probabilistic temporal auto-encoder.

11. The computing device according to claim 10, wherein a number of auto-encoded temporal patterns output by the temporal auto-encoder is less than a number of input multivariate time series data.

12. A computer-implemented method of multivariate time series modeling and forecasting, the computer-implemented method comprising:
encoding a plurality of inputs of multivariate time series data;
mapping the encoded multivariate time series data to a lower-dimensional latent space;
predicting next values in time of the encoded multivariate time series data in the lower dimensional latent space;
mapping the predicted next values and a random noise back to an input space to provide a predictive distribution sample for a next time points of the multivariate time series data; and
outputting one or more time series forecasts based on the predictive distribution sample.

13. The computer-implemented method according to claim 12, wherein the encoding of the plurality of multivariate time series data is performed by temporal auto-encoding.

14. The computer-implemented method according to claim 12, wherein the encoding of the plurality of multivariate time series data is performed by probabilistic temporal auto-encoding.

15. The computer-implemented method according to claim 13, wherein a number of auto-encoded input multivariate time series data is greater than a number of auto-encoded temporal patterns output by the temporal auto-encoder.

16. The computer-implemented method according to claim 13, wherein the mapping of the encoded multivariate time series data to a lower-dimensional latent space comprises a non-linear mapping.

17. The computer-implemented method according to claim 13, further comprising:
training a neural network deep learning model to compute a time series modeling and the one or more time series forecasts.

18. The computer-implemented method according to claim 13, further comprising:
providing an end-to-end deep learning model and training the end-to-end deep learning model using a stochastic gradient descent.

19. The computer-implemented method according to claim 13, further comprising forming the input multivariate time series data and the exogenous factor data as a 3D array, with a third dimension corresponding to features of the exogenous factor data.

20. A non-transitory computer-readable storage medium tangibly embodying a computer-readable program code having computer-readable instructions that, when executed, causes a computer device to perform a method of multivariate time series modeling and forecasting, the method comprising:
encoding a plurality of inputs of multivariate time series data;
mapping the encoded multivariate time series data to a lower-dimensional latent space;
predicting next values in time of the encoded multivariate time series data in the lower dimensional latent space;
mapping the predicted next values and a random noise back to an input space to provide a predictive distribution sample for a next time points of the multivariate time series data; and
outputting one or more time series forecasts based on the predictive distribution sample.
